(19) United States
(12) Patent Application Publication
(10) Pub. No.: US 2022/0289576 A1
(43) Pub. Date: Sep. 15, 2022

(54) DISPERSIONS

(71) Applicant: APPLIED GRAPHENE MATERIALS UK LIMITED, Redcar (GB)

(72) Inventors: William Weaver, Redcar (GB); Lynn Chikosha, Redcar (GB); J Pflaumer, Redcar (GB); S Appleyard, Redcar (GB); R Weddell, Redcar (GB)

(21) Appl. No.: 17/625,557

(22) PCT Filed: Jul. 8, 2020
(86) PCT No.: PCT/GB2020/051646

§ 371 Date: Jan. 7, 2022

(30) Foreign Application Priority Data
Jul. 9, 2019 (GB) 1909803.7

(51) Int. Cl. C01B 32/194; C01B 32/21

(52) U.S. Cl. CPC C01B 32/194; C01B 32/21; C01B 2204/04; C01P 2004/24; C01P 2006/22

(57) ABSTRACT

A method of forming a liquid dispersion of 2D material/graphitic nanoplatelets is disclosed. The method comprises the steps of (1) creating a dispersing medium; (2) mixing the 2D material/graphitic nanoplatelets into the dispersing medium; and (3) subjecting the 2D material/graphitic nanoplatelets to sufficient shear forces and or crushing forces to reduce the particle size of the 2D material/graphitic nanoplatelets. The liquid dispersion comprises the 2D material/graphitic nanoplatelets, at least one grinding media, and at least one non-aqueous solvent.

### TECHNOLOGICAL FIELD

This invention relates to dispersions and, in particular, to dispersions comprising two-dimensional (2D) materials and methods for making such dispersions.

### BACKGROUND

2D materials as referenced herein are comprised of one or more of the known 2D materials and or graphite flakes with at least one nanoscale dimension, or a mixture thereof. They are collectively referred to herein as “2D material/graphitic nanoplatelets” or “2D material/graphitic nanoplates”.

2D materials (sometimes referred to as single layer materials) are crystalline materials consisting of a single layer of atoms or up to several layers. Layered 2D materials consist of 2D layers weakly stacked or bound to form three dimensional structures. Nanoplates of 2D materials have thicknesses within the nanoscale or smaller and their other two dimensions are generally at scales larger than the nanoscale.

Known 2D nanomaterials, include but are not limited to, graphene (C), graphene oxide, reduced graphene oxide, hexagonal boron nitride (hBN), molybdenum disulphide (MoS₂), tungsten diselenide (WSe₂), silicene (Si), germanene (Ge), Graphyne (C), borophene (B), phosphorene (P), or 2D vertical or in-plane heterostructures of two of the aforesaid materials.

Graphite nanoplates with at least one nanoscale dimension are comprised of between 10 and 40 layers of carbon atoms and have lateral dimensions ranging from around 100 nm to 100 μm.

2D material/graphitic nanoplatelets and in particular graphene and hexagonal boron nitride have many properties of interest in the materials world and more properties are being discovered. A significant challenge to the utilisation of such materials and their properties is that of producing compositions in which such materials are dispersed and that can be made in commercial processes, and which are commercially attractive. In particular, such compositions must have a sufficient storage life/longevity for the substances to be sold, stored for up to a known period, and then used. Further, such compositions need not to be hazardous to the user and/or the environment, or at least any hazard has to be within acceptable limits.

A particular problem faced in connection with 2D material/graphitic nanoplatelets is the poor dispersibility within aqueous and non-aqueous solvents, and once dispersed, the poor stability of such dispersions. For example, graphene nanoplates and/or graphite nanoplates with one nanoscale dimension face this problem in aqueous and non-aqueous solvents. Hexagonal boron nitride nanoplates face the same problems.

For 2D material/graphitic nanoplatelets which are known to be or suspected to be hazardous, especially when not encapsulated in other materials, the stability of those 2D material/graphitic nanoplatelets in dispersions is particularly important because they readily become airborne if they separate out of a dispersion and dry when not bound or encapsulated in a non-airborne substance. Airborne graphene nanoplates and or graphite nanoplates with at least one nanoscale dimension are considered to be potentially damaging to human and animal health if taken into the lungs. The hazards of other 2D material/graphitic platelets are still being assessed but it is believed prudent to assume that other 2D material/graphitic nanoplatelets will offer similar hazards.

2D material/graphitic nanoplatelets have a high surface area and low functionality which has the result that they have historically proven difficult to wet and or disperse within a solution. Furthermore, the aggregation of the 2D material/graphitic nanoplatelets once dispersed is known to be very difficult to prevent.

Improved methods of wetting and achieving dispersion stability have been the subject of intense research since the discovery of 2D material/graphitic nanoplatelets and their properties.

The parameters for creating good dispersions are well established in the field of colloid science and the free energy of any colloid system is determined by both the interfacial area and interfacial tension. The theoretical surface area of a monolayer of graphene is approximately 2590 m²g⁻¹ and consequently there are a limited range of conditions under which it can be dispersed, typically these conditions have included sonication and polar aprotic solvents.

To maintain the stability of graphene/graphitic platelets (where the graphitic nanoplatelets are graphite nanoplates with nanoscale dimensions and 10 to 20 layers and lateral dimensions ranging from around 100 nm to 100 μm) in a dispersion once they have been dispersed requires the generation of an energy barrier to prevent aggregation of those nanoplatelets. This can be achieved by either electrostatic or steric repulsion. If the energy barrier is sufficiently high then Brownian motion will maintain the dispersion. This has been achieved by use of one or more approaches which may be characterised as:

a. Solvent selection;
b. Chemical (covalent) modification of the graphene/graphitic nanoplatelets; and
c. Non-covalent modification of the graphene/graphitic nanoplatelets.
a. Solvent Selection

Several solvents have been identified as being particularly good at dispersing graphene/graphitic platelets, in particular N-Methyl-2-pyrrolidone (NMP), Dimethyl sulfoxide (DMSO), and Dimethylformamide (DMF). These solvents carry with them health and safety problems and it is desirable not to use these solvents.

Solvent interaction has been rationalized in terms of both surface energy and the use of Hansen solubility parameters. Using Hansen solubility parameters has resulted in the identification of several solvents as potential carrier media, their effectiveness is, however, dependent on the functionality of the graphene/graphitic platelets, the mode of dispersion, the time since dispersion and/or the temperature of the dispersion.

Where improved dispersion has been achieved using Hansen solubility parameters this has been thought to be due to the development of a layer of solvent at the surface of the graphene/graphitic platelets. Typically, however, the energy barrier created is created through steric interaction and is small with the result that such dispersions aggregate within days of manufacture.

b. Chemical (Covalent) Modification of Graphene/Graphitic Platelets

Functionalisation of graphene/graphitic nanoplatelets depends significantly on the level of functional group availability. Where oxygen is present (for example in reduced graphene oxide) one of the most popular routes is the use of diazonium salts to introduce functionality.

Alternatively, where there is either no functionality (pure graphene or graphite) or very low functionality, plasma modification may be used to introduce functionality. These graphene/graphitic nanoplatelets may subsequently be further treated to produce new functional species. The most important processing parameter for plasma treatment is the process gas because this determines the chemical groups introduced while the process time and power used impact the concentration of functional groups introduced.

It has been observed that although chemical functionalisation of graphene/graphitic nanoplatelets can improve their dispersibility, that chemical functionalisation can also increase their defectiveness and have a negative impact on their properties. This is clearly an undesirable outcome.

c. Non-Covalent Modification of Graphene/Graphitic Nanoplatelets

Non-covalent modification of graphene/graphitic nanoplatelets has several advantages over covalent modification in that it does not involve additional chemical steps and avoids damage to the sp2 domains within a platelet. There are a range of interactions possible, the principle being π-π, cation −π, and the use of surfactants.

π-π bonding may be achieved either through dispersive or electrostatic interactions. A wide range of aromatic based systems have been shown to interact with graphene such as polyaromatic hydrocarbons (PAH), pyrene, and polyacrylonitrile (PAN).

Cation −π bonding may use either metal or organic cations. Organic cations are generally preferred with imidazolium cations being preferred due to the planar and aromatic structures of those cations.

Surfactants have found wide utilization due to the wide variety of surfactants available commercially. Typically, surfactants will initially be adsorbed at the basal edges of a nanoplate and then be adsorbed at the surface. Adsorption is enhanced if there is a capacity for π-π interaction and a planar tail capable of solvation. Both non-ionic and ionic surfactants have been shown to be effective based on the functionality of the graphene/graphitic nanoplatelets basal edge and surface and the media in which the graphene/graphitic nanoplatelets is being dispersed.

To summarise the discussion above, highly specialised additives are needed to wet, disperse and stabilise dry powders of graphene/graphitic nanoplatelets for use in liquid formulations. The same is understood to be true in connection with other 2D material/graphitic nanoplatelets.

### BRIEF SUMMARY

According to a first aspect of the present invention there is provided a method of forming a liquid dispersion of 2D material/graphitic nanoplatelets comprising the steps of

(1) creating a dispersing medium;
(2) mixing 2D material/graphitic nanoplatelets into the dispersing medium; and
(3) subjecting the 2D material/graphitic nanoplatelets to sufficient shear forces and or crushing force to reduce the particle size of the 2D material/graphitic nanoplatelets using a mechanical means
characterised in that the 2D material/graphitic nanoplatelets and dispersing medium mixture comprises the 2D material/graphitic nanoplatelets, at least one grinding media, and at least one non-aqueous solvent.

According to a second aspect of the present invention there is provided a liquid dispersion comprising 2D material/graphitic nanoplatelets, at least one grinding media, and at least one non-aqueous solvent.

According to a third aspect of the present invention there is provided a liquid coating system comprising a liquid dispersion according to the second aspect of the present invention.

In some embodiments of the first aspect of the present invention the 2D material/graphitic nanoplatelets are comprised of one or more of graphene or graphitic nanoplatelets, in which the graphene nanoplatelets are comprised of one or more of graphene nanoplates, reduced graphene oxide nanoplates, bilayer graphene nanoplates, bilayer reduced graphene oxide nanoplates, trilayer graphene nanoplates, trilayer reduced graphene oxide nanoplates, few-layer graphene nanoplates, few-layer reduced graphene oxide nanoplates, and graphene nanoplates of 6 to 10 layers of carbon atoms, and the graphitic nanoplatelets are comprised of graphite nanoplates with at least 10 layers of carbon atoms.

In some embodiments the present invention one or both of the graphene nanoplatelets and the graphitic nanoplatelets have lateral dimensions ranging from around 100 nm to 100 μm.

In some embodiments of the first aspect of the present invention the 2D material/graphitic nanoplatelets are comprised of one or more of graphitic nanoplatelets, in which the graphitic nanoplatelets are graphite nanoplates with 10 to 20 layers of carbon atoms, graphite nanoplates with 10 to 14 layers of carbon atoms, graphite nanoplates with 10 to 35 layers of carbon atoms graphite nanoplates with 10 to 40 layers of carbon atoms, graphite nanoplates with 25 to 30 layers of carbon atoms, graphite nanoplates with 25 to 35 layers of carbon atoms, graphite nanoplates with 20 to 35 layers of carbon atoms, or graphite nanoplates with 20 to 40 layers of carbon atoms.

In some embodiments of the first aspect of the present invention the 2D material/graphitic nanoplatelets are comprised of one or more of 2D material nanoplatelets, in which the 2D material nanoplatelets are comprised of one or more of hexagonal boron nitride (hBN), molybdenum disulphide (MoS₂), tungsten diselenide (WSe₂), silicene (Si), germanene (Ge), Graphyne (C), borophene (B), phosphorene (P), or a 2D in-plane or vertical heterostructure of two or more of the aforesaid materials.

Few-layer graphene/reduced graphene oxide nanoplates have between 4 and 10 layers of carbon atoms, where a monolayer has a thickness of 0.035 nm and a typical interlayer distance of 0.14 nm.

In some embodiments of the first aspect of the present invention the 2D material/graphitic nanoplatelets are comprised of graphene/graphitic nanoplatelets.

In some embodiments of the first aspect of the present invention the at least one grinding media is solid (which includes powders), the dispersing medium comprises the at least one solid grinding media and the at least one non-aqueous solvent, and the step of creating a dispersing medium comprises

(i) dissolving the at least one solid grinding media in the at least one solvent, and
(ii) mixing the grinding media solution until it is substantially homogenous.

In some embodiments of the first aspect of the present invention the at least one grinding media is liquid, the dispersing medium comprises the at least one liquid grinding media and the at least one non-aqueous solvent, and the step of creating a dispersing medium comprises

(i) mixing the grinding media solution in the at least one non-aqueous solvent until it is substantially homogenous.

In some embodiments of the first aspect of the present invention the method further comprises the steps of

(iii) adding the 2D material/graphitic nanoplatelets to the at least one grinding media solution following completion of step (ii) for a solid at least one grinding media or (i) for a liquid at least one grinding media, and
(iv) mechanically mixing the 2D material/graphitic nanoplatelets and the at least one grinding media solution mixture until the 2D material/graphitic nanoplatelets are substantially dispersed in the grinding media solution.

Preferred grinding media include but are not limited to grinding resin, polymers modified with strong anchoring groups, aldehyde resins, and Laropal (trade mark) A81 which is an aldehyde resin. Laropal A81 is commercially available from BASF, Dispersions & Resins Division, North America.

Preferred non-aqueous solvents for use in the present invention include but are not limited to organic solvents. Preferred solvents are or comprise butyl acetate, xylene, ethyl acetate, methyl ethyl ketone, butanol, 2 butoxyethanol, other glycol ethers, acetone, dimethyl carbonate, methyl acetate, parachlorobenzotrifluoride, Cert-butyl acetate, propylene carbonate and (1R)-7,8-Dioxabicyclo[3.2.1]octan-2-one, or a mixture of two or more of these solvents. (1R)-7,8-Dioxabicyclo[3.2.1]octan-2-one is commercially available as Cyrene (trade mark) from Merck KGaA, Germany.

In some embodiments, the addition of the solvent follows a predetermined period of operation of the dispersing means.

Dry 2D material/graphitic nanoplatelets, for example graphene/graphitic nanoplatelets, are typically made up of agglomerates or aggregates of primary particles or nanoplatelets. During the dispersion process those agglomerates or aggregates have to be broken down, as far as possible, into primary particles or nanoplatelets of a size suitable for the intended application of the 2D material/graphitic nanoplatelets.

In some embodiments of the present invention the dispersing means is a means suitable to apply both a crushing action and a mechanical shearing force to the 2D material/graphitic nanoplatelets whilst those materials are mixed in with the dispersing medium. Suitable apparatus to achieve this are known grinding or milling apparatus such as dissolvers, bead mills or three-roll mills.

In some embodiments of the present invention it is preferred that the agglomerates or aggregates are broken down to particles or nanoplatelets of a particle size which cannot be broken down further. This is beneficial because the manufacture and storage of 2D material/graphitic nanoplatelets prior to their use is often in the form of particles that are larger than desired for 2D material/graphitic nanoplatelet dispersions.

Once the 2D material/graphitic nanoplatelets agglomerates or aggregates are reduced to smaller particles or nanoplatelets, rapid stabilisation of the newly formed surfaces resultant from the reduction in size of the agglomerates or aggregates helps to prevent the particles or nanoplatelets re-agglomerating or re-aggregating.

The method of the present invention is particularly beneficial because it has been found that the higher the interfacial tension between a dispersing medium, for example a dispersing medium which comprises a solvent and 2D material/graphitic nanoplatelets, the stronger are the forces tending to reduce the interfacial area. In other words, the stronger are the forces tending to re-agglomerate or re-aggregate the 2D material/graphitic nanoplatelets or to form flocculates. Wetting agents are commonly used to achieve a control of the interfacial tension between the dispersing medium and the 2D material/graphitic nanoplatelets. In this manner the wetting agent helps stabilise the newly formed surfaces and prevent the 2D material/graphitic nanoplatelets agglomerating, aggregating and or flocculating.

The action of the wetting agent in stabilising the newly formed surfaces and preventing the 2D material/graphitic nanoplatelets agglomerating, aggregating and or flocculating is beneficial but has been found to have the following negative consequences:

a) It is a feature of 2D material/graphitic nanoplatelets that they have a high surface area relative to other compounds. This high surface area has the result that the 2D material/graphitic nanoplatelets will effectively bond with all of the wetting agent in the dispersing medium. This will have the effect that other compounds in the dispersing medium are found to settle out of the dispersion more quickly than is desirable.
b) An increase in the proportion of the wetting agent in the dispersing medium may, ultimately lead to a dispersion in which all the components remain suspended. This approach to forming a dispersion has the problem, however, that coatings formed from the dispersion will have a high degree of solubility in water. This is very undesirable because it leads to the rapid failure of the coating.

According to the present invention the application of a crushing action and or mechanical shearing forces by a dispersion means to a mixture of 2D material/graphitic nanoplatelets in a grinding media and solvent solution results in an improved dispersion.

An advantage of the method of the present invention is that the milling performance of the dispersion means when acting on 2D material/graphitic nanoplatelets, is further improved by the presence of the grinding media in the mixture being milled. That improvement is exhibited by faster milling, lower heat generation in the milling process, a more uniform particle size in the dispersion, a smaller D50 particle size in the dispersion, a lower dispersion viscosity, a greater storage stability relative to known short shelf life dispersions, and an ability to re-disperse any combined grinding resin/2D material/graphitic nanoplatelet particles that have settled out of the dispersion by simple agitation of the dispersion.

According to a second aspect of the present invention there is provided a liquid dispersion comprising 2D material/graphitic nanoplatelets, at least one grinding media, and at least one non-aqueous solvent.

In some embodiments of the second aspect of the present invention the 2D material/graphitic nanoplatelets are comprised of one or more of graphene nanoplatelets, graphitic nanoplatelets, and 2D material nanoplatelets and in which the graphene nanoplatelets are comprised of one or more of graphene nanoplates, reduced graphene oxide nanoplates, bilayer graphene nanoplates, bilayer reduced graphene oxide nanoplates, trilayer graphene nanoplates, trilayer reduced graphene oxide nanoplates, few-layer graphene nanoplates, few-layer reduced graphene oxide nanoplates, and graphene nanoplates of 6 to 10 layers of carbon atoms, and the graphitic nanoplatelets are comprised of graphite nanoplates with at least 10 layers of carbon atoms, the graphitic nanoplatelets are comprised of one or more of graphite nanoplates with 10 to 20 layers of carbon atoms, graphite nanoplates with 10 to 14 layers of carbon atoms, graphite nanoplates with 10 to 35 layers of carbon atoms graphite nanoplates with 10 to 40 layers of carbon atoms, graphite nanoplates with 25 to 30 layers of carbon atoms, graphite nanoplates with 25 to 35 layers of carbon atoms, graphite nanoplates with 20 to 35 layers of carbon atoms, or graphite nanoplates with 20 to 40 layers of carbon atoms, and the 2D material nanoplatelets are comprised of one or more of hexagonal boron nitride (hBN), molybdenum disulphide (MoS₂), tungsten diselenide (WSe₂), silicene (Si), germanene (Ge), Graphyne (C), borophene (B), phosphorene (P), or a 2D in-plane or vertical heterostructure of two or more of the aforesaid materials.

In some embodiments of the second aspect of the present invention the at least one grinding media is comprised of one or more of a grinding resin, a polymer modified with strong anchoring groups, an aldehyde resins, or a mixture of two or more of such media. Preferred grinding media include but are not limited to Laropal (trade mark) A81 which is an aldehyde resin which is commercially available from BASF, Dispersions & Resins Division, North America

In some embodiments of the second aspect of the present invention the at least one non-aqueous solvent is comprised of one or more of an organic solvent, butyl acetate, xylene, ethyl acetate, methyl ethyl ketone, butanol, 2 butoxyethanol, other glycol ethers, acetone, dimethyl carbonate, methyl acetate, parachlorobenzotrifluoride, Cert-butyl acetate, propylene carbonate and (1R)-7,8-Dioxabicyclo[3.2.1]octan-2-one, or a mixture of two or more of these solvents. (1R)-7,8-Dioxabicyclo[3.2.1]octan-2-one is commercially available as Cyrene (trade mark) from Merck KgaA, Germany.

In some embodiments of the second aspect of the present invention the liquid dispersion is manufactured using a method according to the first aspect of the present invention.

### BRIEF DESCRIPTION

For a better understanding of various examples that are useful for understanding the detailed description, reference will now be made by way of example only to the accompanying drawings in which:

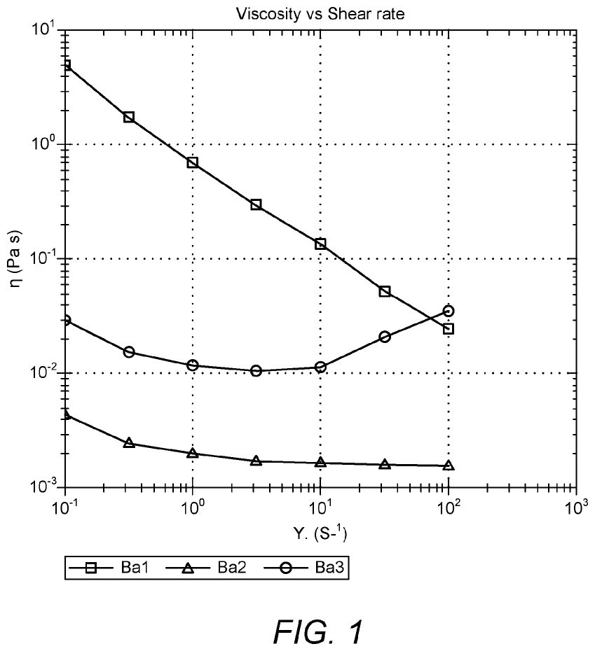

FIG. 1 provides a graph showing the relationship between viscosity and shear rate for samples BA1 to BA3 of table 1;

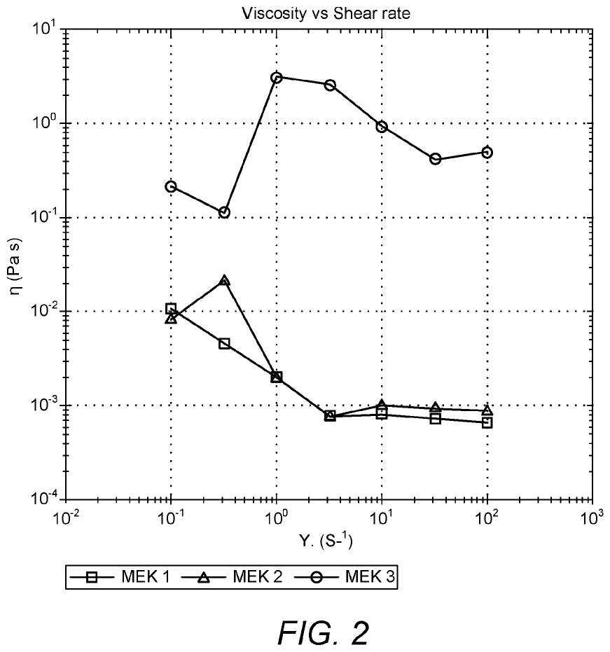

FIG. 2 provides a graph showing the relationship between viscosity and shear rate for samples MEK1 to MEK3 of table 6; and

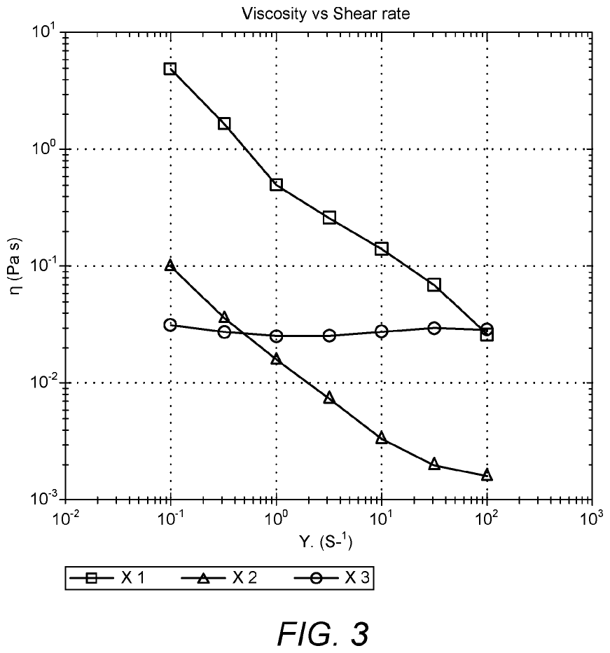

FIG. 3 provides a graph showing the relationship between viscosity and shear rate for samples X1 to X3 of table 11.

### DETAILED DESCRIPTION

### Examples

Dispersions of graphene/graphitic materials were manufactured using the methods of the present invention and comparative samples made using other techniques.

All dispersions were manufactured on a horizontal beadmill. Dispersions were milled for 15 minutes on recirculation mode at maximum speed.

### Characterisation of Dispersions

Particle size was measured on a Mastersizer 3000 to determine the effectiveness of the grinding resin and dispersant in deagglomeration and particle size reduction.

Viscosity was measured to aid understanding of the rheological properties of the dispersion. This was done using a Kinexus Rheometer.

Storage stability was determined through the use of a Turbiscan Stability Analyser. Turbiscan stability index (TSI) is a relative measure of stability, which allows comparison of multiple samples. As a relative measure, it allows for a quantifiable assessment of closely related formulations.

### Example 1: Dispersion of Graphitic Material A-GNP10 in Butyl Acetate

Samples of dispersions referenced as BA1 to BA3 were made up including graphitic material A-GNP10 and butyl acetate as shown in Table 1.

TABLE 1

| | Graphene/ | | | |
|---|---|---|---|---|
| Sample | Graphitic | | | |
| Reference | material | Grinding resin | Wetting agent | Solvent |
| BA1 | 10 wt % AGNP-10 | — | — | Butyl acetate |
| BA2 | 10 wt % AGNP-10 | — | DISPERBYK-2150 | Butyl acetate |
| BA3 | 10 wt % AGNP-10 | Laropal A81 | — | Butyl acetate |

Graphitic material A-GNP10 is commercially available from Applied Graphene Materials UK Limited, UK and comprises graphite nanoplatelets of between 25 and 35 layers of atoms thick. The graphite nanoplatelets are supplied as a powder and are generally aggregated into clumps of nanoplatelets.

Each of samples BA1 to BA3 was made up using the following steps:

1 To the butyl acetate any grinding resin and or wetting agent present in the sample was added. This was stirred until any solids were dissolved and the mixture was substantially homogenous;
2 The 10 wt % of AGNP-10 was calculated on the basis of the weight of the butyl acetate and added to the mixture and stirred until the powder was evenly dispersed in the mixture;
3 The mixture was bead milled for 15 minutes recirculation in a bead mill using beads.

TABLE 2
Particle Size Distribution of Butyl Acetate Dispersions

| Sample | | Particle Size Distribution (μm) | | |
|---|---|---|---|---|
| Reference | GNP Type | D × 10 | D × 50 | D × 90 |
| BA1 | A-GNP10 | 0.0145 | 0.03 | 4.29 |
| BA2 | A-GNP10 | 0.026 | 0.803 | 4.81 |
| BA3 | A-GNP10 | 0.18 | 1.16 | 7.99 |

TABLE 3
Viscosity of butyl acetate dispersions measured on manufacture at
a shear rate (\dot{γ}) of 10 s⁻¹ at 23° C.

| Sample | | Initial Viscosity |
|---|---|---|
| Reference | GNP Type | (Pa · s) |
| BA1 | A-GNP10 | 0.13 |
| BA2 | A-GNP10 | 0.0017 |
| BA3 | A-GNP10 | 0.011 |

FIG. 1 provides a graph showing the relationship between viscosity and shear rate for samples BA1 to BA3 of table 1.

TABLE 4
Storage stability of butyl acetate dispersions

| Sample | |
|---|---|
| Reference | Stability Comment (4 weeks at 40 C.) |
| BA1 | Development of clear liquid phase and sediment |
| BA2 | No clear phase but some sediment |
| BA3 | No clear phase but some sediment |

TABLE 5

| | | | |
|---|---|---|---|
| Sample: | BA1 | BA2 | BA3 |

| | | | |
|---|---|---|---|
| TSI Index | 0.25 | 0.55 | 0.15 |

| | | | | | |
|---|---|---|---|---|---|
| Clear layer development | 9 | days | 9 | days | none |
| (days) | | | | | |
| Clear layer thickness (at | 2 | mm | 1 | mm | 0 |
| 35 d) | | | | | |

The use of a wetting agent provides marginal improvement to a graphene dispersion in Butyl Acetate. Use of a grinding resin significantly reduces sedimentation and synereisis while not impacting final performance characteristics.

### Example 2: Dispersion of Graphitic Material A-GNP10 in Methyl Ethyl Ketone

Samples of dispersions referenced as MEK1 to MEK3 were made up including graphitic material A-GNP10 and methyl ethyl ketone as shown in Table 6.

TABLE 6

| | Graphene/ | | | |
|---|---|---|---|---|
| Sample | Graphitic | | | |
| Reference | material | Grinding resin | Wetting agent | Solvent |
| ΛΛEK1 | 10 wt % AGNP-10 | — | — | Methyl ethyl |
| | | | | ketone |
| MEK2 | 10 wt % AGNP-10 | — | DISPERBYK-2150 | Methyl ethyl |
| | | | | ketone |
| MEK3 | 10 wt % AGNP-10 | Laropal A81 | — | Methyl ethyl |
| | | | | ketone |

Each of samples MEK1 to MEK3 was made up using the same steps as used in connection with samples BA1 to BA3 as set out above.

TABLE 7
Particle Size Distribution of MEK Dispersions

| Sample | | Particle Size Distribution (μm) | | |
|---|---|---|---|---|
| Reference | GNP Type | D × 10 | D × 50 | D × 90 |
| MEK1 | A-GNP10 | 0.388 | 3.03 | 13.2 |
| MEK2 | A-GNP10 | 0.28 | 2.66 | 12.9 |
| MEK3 | A-GNP10 | 0.62 | 7.75 | 17.7 |

TABLE 8
Viscosity of MEK Dispersions measured on manufacture at a shear
rate (\dot{γ}) of 10 s⁻¹ at 23° C.

| Sample | | Initial Viscosity |
|---|---|---|
| Reference | GNP Type | (Pa · s) |
| MEK1 | A-GNP10 | 0.000826 |
| MEK2 | A-GNP10 | 0.00104 |
| MEK3 | A-GNP10 | 0.9375 |

FIG. 2 provides a graph showing the relationship between viscosity and shear rate for samples MEK1 to MEK3 of table 6.

TABLE 9
Storage stability of MEK Dispersions

| Sample | |
|---|---|
| Reference | Stability Comment (4 weeks) at 40 C. |
| MEK1 | Significant Hard Sediment |
| MEK2 | Soft Sediment |
| MEK3 | Soft Sediment |

TABLE 10

| Sample: | MEK1 | | MEK2 | MEK3 |
|---|---|---|---|---|
| TSI Index | 1.5 | | 0.55 | 0.1 |
| Clear layer development | 5 | days | none | none |
| (days) | | | | |
| Clear layer thickness (at | 5 | mm | 0 | 0 |
| 35 d) | | | | |

The use of a wetting agent provides improvement to a graphene dispersion in Methyl Ethyl Ketone. Use of a grinding resin however significantly improves dispersion stability as demonstrated in the resulting TSI and no significant destabilisation. No impact on final performance characteristics was observed.

### Example 3: Dispersion of Graphitic Material A-GNP10 in Xylene

Samples of dispersions referenced as X1 to X3 were made up including graphitic material A-GNP10 and xylene as shown in Table 11.

TABLE 11

| | Graphene/ | | | |
|---|---|---|---|---|
| Sample | Graphitic | | | |
| Reference | material | Grinding resin | Wetting agent | Solvent |
| X1 | 10 wt % AGNP-10 | — | — | Xylene |
| X2 | 10 wt % AGNP-10 | — | DISPERBYK-2150 | Xylene |
| X3 | 10 wt % AGNP-10 | Laropal A81 | — | Xylene |

Each of samples X1 to X3 was made up using the same steps as used in connection with samples BA1 to BA3 as set out above.

TABLE 12
Particle Size Distribution of Xylene Dispersions

| Sample | | Particle Size Distribution (μm) | | |
|---|---|---|---|---|
| Reference | GNP Type | D × 10 | D × 50 | D × 90 |
| X1 | A-GNP10 | 1.05 | 2.36 | 6.67 |
| X2 | A-GNP10 | 0.43 | 3.61 | 14.4 |
| X3 | A-GNP10 | 0.94 | 3.13 | 15.3 |

TABLE 13
Viscosity of MEK Dispersions measured on manufacture at a shear
rate (\dot{γ}) of 10 s⁻¹ at 23° C.

| Sample | | Initial Viscosity |
|---|---|---|
| Reference | GNP Type | (Pa.s) |
| X1 | A-GNP10 | 0.1453 |
| X2 | A-GNP10 | 0.00337 |
| X3 | A-GNP10 | 0.2846 |

FIG. 3 provides a graph showing the relationship between viscosity and shear rate for samples X1 to X3 of table 11

TABLE 14
Storage stability of Xylene Dispersions

| Sample | |
|---|---|
| Reference | Stability Comment (4 weeks) |
| X1 | Significant Sedimentation |
| X2 | Significant Sedimentation |
| X3 | Thin wall of Sediment on glass |

TABLE 15

| | | | |
|---|---|---|---|
| Sample: | X1 | X2 | X3 |

| | | | |
|---|---|---|---|
| TSI Index | 1 | 0.8 | 0.15 |

| | | | | | |
|---|---|---|---|---|---|
| Clear layer development | 2 | days | 6 | days | none |
| (days) | | | | | |
| Clear layer thickness (at | 8 | mm | 2 | mm | 0 |
| 35 d) | | | | | |

The use of a wetting agent provides marginal improvement to a graphene dispersion in Xylene. Use of a grinding resin however significantly reduces sedimentation and synereisis as demonstrate, while the resulting TSI indicates no significant destabilisation. No impact on final performance characteristics was observed.

1. A method of forming a liquid dispersion of 2D material/graphitic nanoplatelets comprising the steps of:
(1) creating a dispersing medium by mixing at least one grinding media and at least one non-aqueous solvent until the grinding media and non-aqueous solvent mixture is substantially homogenous, wherein the at least one grinding media comprises an aldehyde resin;
(2) mixing the 2D material/graphitic nanoplatelets into the dispersing medium; and
(3) subjecting the 2D material/graphitic nanoplatelets to sufficient shear forces and or crushing forces to reduce the particle size of the 2D material/graphitic nanoplatelets;
characterised in that the liquid dispersion comprises the 2D material/graphitic nanoplatelets, the at least one grinding media, and the at least one non-aqueous solvent
in which the 2D material/graphitic nanoplatelets are comprised of one or more of graphene nanoplatelets, graphitic nanoplatelets, and 2D material nanoplatelets and in which
the graphene nanoplatelets are comprised of one or more of graphene nanoplates, reduced graphene oxide nanoplates, bilayer graphene nanoplates, bilayer reduced graphene oxide nanoplates, trilayer graphene nanoplates, trilayer reduced graphene oxide nanoplates, few-layer graphene nanoplates, few-layer reduced graphene oxide nanoplates, and graphene nanoplates of 6 to 10 layers of carbon atoms, and the graphitic platelets are comprised of graphite nanoplates with at least 10 layers of carbon atoms, the graphitic platelets are comprised of one or more of graphite nanoplates with 10 to 20 layers of carbon atoms, graphite nanoplates with 10 to 14 layers of carbon atoms, graphite nanoplates with 10 to 35 layers of carbon atoms, graphite nanoplates with 10 to 40 layers of carbon atoms, graphite nanoplates with 25 to 30 layers of carbon atoms, graphite nanoplates with 25 to 35 layers of carbon atoms, graphite nanoplates with 20 to 35 layers of carbon atoms, or graphite nanoplates with 20 to 40 layers of carbon atoms, and the 2D material nanoplatelets are comprised of one or more of hexagonal boron nitride (hBN), molybdenum disulphide (MoS₂), tungsten diselenide (WSe₂), silicene (Si), germanene (Ge), Graphyne (C), borophene (B), phosphorene (P), or a 2D in-plane or vertical heterostructure of two or more of the aforesaid materials.

2. (canceled)

3. (canceled)

4. A method according to claim 1 in which the at least one non-aqueous solvent is comprised of one or more of an organic solvent, butyl acetate, xylene, ethyl acetate, methyl ethyl ketone, butanol, 2 butoxyethanol, other glycol ethers, acetone, dimethyl carbonate, methyl acetate, parachlorobenzotrifluoride, tert-butyl acetate, propylene carbonate and (1R)-7,8-Dioxabicyclo[3.2.1]octan-2-one, or a mixture of two or more of these solvents.

5. (canceled)

6. (canceled)

7. A method according to claim 1 in which the step (3) of subjecting the 2D material/graphitic nanoplatelets and dispersing medium mixture to shear forces and or crushing forces is performed using one or more of a dissolver, a bead mill, or a three-roll mill.

8. A liquid dispersion comprising 2D material/graphitic nanoplatelets, at least one grinding media, and at least one non-aqueous solvent,
wherein the at least one grinding media comprises an aldehyde resin,
in which the 2D material/graphitic nanoplatelets are comprised of one or more of graphene nanoplatelets, graphitic nanoplatelets, and 2D material nanoplatelets, and in which
the graphene nanoplatelets are comprised of one or more of graphene nanoplates, reduced graphene oxide nanoplates, bilayer graphene nanoplates, bilayer reduced graphene oxide nanoplates, trilayer graphene nanoplates, trilayer reduced graphene oxide nanoplates, few-layer graphene nanoplates, few-layer reduced graphene oxide nanoplates, and graphene nanoplates of 6 to 10 layers of carbon atoms, and the graphitic platelets are comprised of graphite nanoplates with at least 10 layers of carbon atoms, the graphitic platelets are comprised of one or more of graphite nanoplates with 10 to 20 layers of carbon atoms, graphite nanoplates with 10 to 14 layers of carbon atoms, graphite nanoplates with 10 to 35 layers of carbon atoms, graphite nanoplates with 10 to 40 layers of carbon atoms, graphite nanoplates with 25 to 30 layers of carbon atoms, graphite nanoplates with 25 to 35 layers of carbon atoms, graphite nanoplates with 20 to 35 layers of carbon atoms, or graphite nanoplates with 20 to 40 layers of carbon atoms, and the 2D material nanoplatelets are comprised of one or more of hexagonal boron nitride (hBN), molybdenum disulphide (MoS₂), tungsten diselenide (WSe₂), silicene (Si), germanene (Ge), Graphyne (C), borophene (B), phosphorene (P), or a 2D in-plane or vertical heterostructure of two or more of the aforesaid materials.

9. (canceled)

10. (canceled)

11. A liquid dispersion according to claim 8 in which the at least one non-aqueous solvent is comprised of one or more of an organic solvent, butyl acetate, xylene, ethyl acetate, methyl ethyl ketone, butanol, 2 butoxyethanol, other glycol ethers, acetone, dimethyl carbonate, methyl acetate, parachlorobenzotrifluoride, tert-butyl acetate, propylene carbonate and (1R)-7,8-Dioxabicyclo[3.2.1]octan-2-one, or a mixture of two or more of these solvents.

12. A liquid dispersion according to claim 8 manufactured using a method according to claim 1.

13. A liquid coating composition comprising a liquid dispersion according to claim 8.
